(19) United States
(12) Patent Application Publication
(10) Pub. No.: US 2011/0050384 A1
(43) Pub. Date: Mar. 3, 2011

(54) Termal fuse

(75) Inventors: Jianhua Chen, Sunnyvale, CA (US); Martyn A. Matthiesen, Fremont, CA (US); Antonio F. Contreras, Fremont, CA (US)

(73) Assignee: Tyco Electronics Corporation, Berwyn, PA (US)

(21) Appl. No.: 12/583,981

(22) Filed: Aug. 27, 2009

(51) Int. Cl. H01H 85/06

(52) U.S. Cl. 337/296

(57) ABSTRACT

A thermal fuse includes a first contact surface connected to a top surface of a sensor and a bottom surface connected to a bottom surface of the sensor. The sensor includes a mixture of Sn and Zn. The distance between the top surface and the bottom surface of the sensor is sized to substantially limit Zn depletion in a center region of the sensor when a temperature of the sensor is below a melting temperature of the sensor. The center region of the sensor prevents the first contact surface and the second contact surface from separating when the temperature of the sensor is below the melting temperature, and the first contact surface and the second contact surface are configured to separate when the temperature of the center region of the sensor exceeds the melting temperature of the sensor.

### BACKGROUND

I. Field

The present invention relates generally to electronic protection circuitry. More, specifically, the present invention relates to a thermal fuse.

II. Background Details

Protection circuits are often utilized in electronic circuits to isolate failed circuits from other circuits. For example, protection circuits may be utilized to prevent a cascade failure of circuit modules in an electronic automotive engine controller, or other damage.

One type of protection circuit is a thermal fuse. A thermal fuse functions similar to a typical glass fuse. That is, under normal operating conditions the fuse behaves like a short circuit and during a fault condition the fuse behaves like an open circuit. Thermal fuses transition between these two modes of operation when the temperature of the thermal fuse exceeds an activation temperature. To facilitate these modes, thermal fuses may include a conduction element, such as a fusible wire, a set of metal contacts, or set of soldered metal contacts, that can switch from a conductive to a non-conductive state. The metal contacts are typically coupled to one another with a sensor that may be a form of solder. The sensor may correspond to a low melting point alloy that melts at a melting temperature that corresponds to the activation temperature of the thermal fuse.

In operation, current flows through the thermal fuse. After the sensor reaches the specified activation temperature, the sensor may release the metal contacts, which changes the state of the thermal fuse from a closed state to an open state. This in turn prevents current from flowing through the thermal fuse.

One disadvantage with existing thermal fuses is that because a sensor of a thermal fuse may deteriorate over time when utilized in high temperature environments, existing thermal fuses often have a limited life expectancy. For example, when a thermal fuse is utilized in high temperature environments, the melting point of the sensor may increase over time to a point where it is unable to prevent damage to other circuits.

### SUMMARY

In one aspect, a thermal fuse includes a first contact surface connected to a top surface of a sensor and a second contact surface connected to a bottom surface of the sensor. The sensor includes a mixture of tin (Sn) and zinc (Zn). The distance between the top surface and the bottom surface of the sensor is sized to substantially reduce the rate of Zn in a center region of the sensor when a temperature of the sensor is below a melting temperature of the sensor. The center region of the sensor prevents the first contact surface and the second contact surface from separating when the temperature of the sensor is below the melting temperature, and the first contact surface and the second contact surface are configured to separate when the temperature of the center region of the sensor exceeds the melting temperature of the sensor.

In a second aspect, a thermal fuse includes a first contact surface connected to a top surface of a sensor and a second contact surface connected to a bottom surface of the sensor. The sensor includes a mixture of Sn and Zn. The first and second contact surfaces are made of an element that limits Zn migration out of the sensor and onto either the first or the second contact surface when a temperature of the sensor is below a melting temperature of the sensor. The first contact surface and the second contact surface are configured to separate when the temperature of the sensor exceeds the melting temperature.

In a third aspect, a thermal fuse includes a first and a second contact surface. nickel (Ni) layers are deposited on the first and second contact surfaces and a sensor is disposed between the Ni layers. The sensor includes a mixture of Sn and Zn. The Ni layers are configured to substantially prevent Zn migration onto the first and second contact surfaces. The first contact surface and the second contact surface are configured to separate when the temperature of the sensor exceeds a melting temperature of the sensor.

### BRIEF DESCRIPTION OF THE DRAWINGS

FIG. 1 is an exemplary thermal fuse configured to minimize Zn migration from a sensor.

FIG. 2 illustrates the effects of Zn migration on the composition of a sensor.

FIG. 3 illustrates a second embodiment of a sensor configuration for minimizing Zn migration from a sensor.

FIG. 4A is a schematic representation of a circuit that includes a thermal fuse in a closed state.

FIG. 4B is a schematic representation of a circuit that includes a thermal fuse in an open state.

FIG. 5A illustrates a second exemplary thermal fuse in a closed state.

FIG. 5B illustrates the second exemplary thermal fuse in an open state.

### DETAILED DESCRIPTION

To overcome the problems described above, various thermal fuse configurations are disclosed. The thermal fuses include sensors configured to minimize Zn migration so that the activation temperature of the sensor is maintained when the thermal fuse is utilized in a high temperature environment.

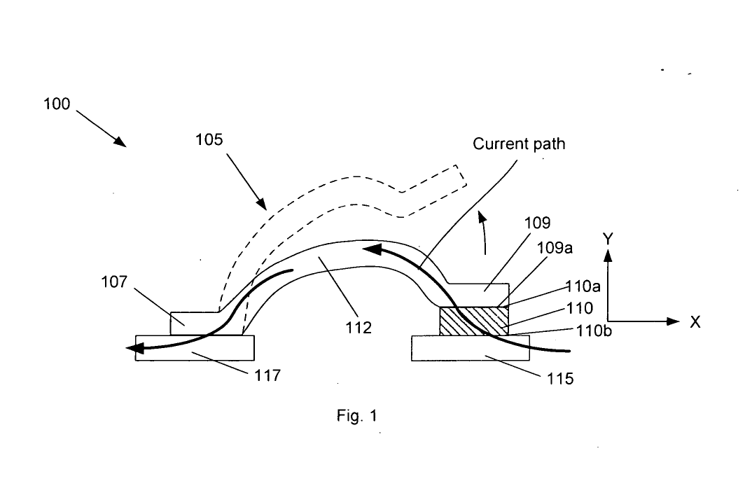

FIG. 1 is an exemplary thermal fuse 100. The thermal fuse 100 includes a spring bar 105, a sensor 110, a first substrate 115 and a second substrate 117.

The spring bar 105 may include a first end 109, a curved section 112, and a second end 107. The first end 109 of the spring bar 105 includes a contact surface 109a configured to adhere to a top surface 110a of the sensor 110. The second end 107 of the spring bar 105 is fastened to the second substrate 117. For example, the second end 107 may be soldered, spot welded, and/or riveted to the second substrate 117. The spring bar 105 may be made from a conductive material, such as a metal or alloy. The spring bar 105 may have elastic characteristics that enable the spring bar 105 to open in a spring-like manner when the temperature of the thermal fuse 100 reaches an activation temperature. For example, the activation temperature may be about 199° C.

The sensor 110 has a width across an X axis, a thickness along a Y axis, a top surface 110a, and a bottom surface 110b. The top surface 110a of the sensor 110 is configured to adhere to the contact surface 109a on the first end 109 of the spring bar 105. The bottom surface 110b is configured to adhere to the first substrate 115. In one implementation, the sensor 110 may be made of an alloy that is in a solid state below a melting temperature of the alloy. When the temperature of the alloy rises above the melting temperature, the sensor 110 may melt or lose its resilience. The melting temperature may correspond to the activation temperature of the thermal fuse 100. For example, in automotive applications the activation temperature of the thermal fuse 100 may be about 199° C. In one implementation, the sensor 110 may be configured to have a melting temperature of about 199° C.

In some implementations, the sensor 110 may be a form of solder and may include a mixture of Sn and Zn. The solder may include other elements. For example, the solder may include mixtures of Sn/Zn/bismuth (Bi), Sn/Zn/aluminum (Al), Sn/Zn/indium (In), Sn/Zn/gallium (Ga), Sn/Zn/In/Bi, and Sn/Zn/silver (Ag). The ratio of the Sn to Zn may be 91 parts Sn to 9 parts Zn by weight. The alloy formed from the combination of Sn and Zn has a melting point of about 199° C.

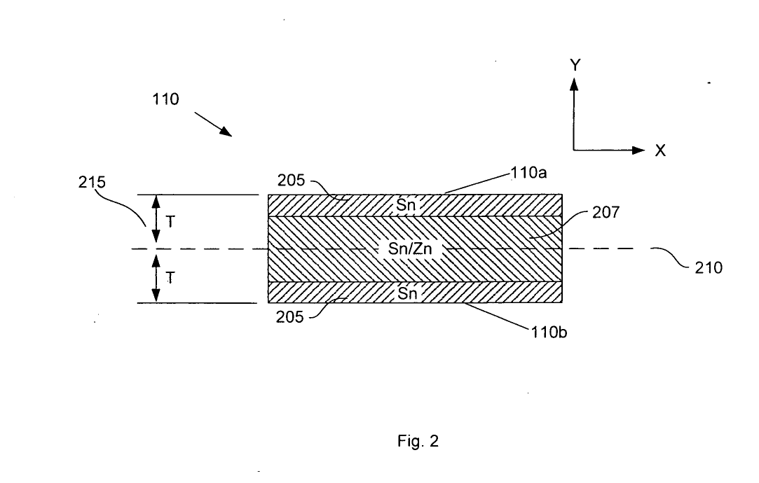

It can be shown that Zn in the sensor 110 tends to migrate out of the sensor 110 and onto the contact surface 110a and substrate 115 at a rate that is dependent on temperature of the sensor 110, the humidity surrounding the sensor 110, the composition of the contact surfaces that contact the sensor 110, and the thickness of the sensor 110. When Zn migrates out of the sensor 110, the ratio of Sn to Zn may increase in certain regions as shown in FIG. 2

FIG. 2 illustrates the effects of Zn migration on the composition of the sensor 110. Referring to FIG. 2, the sensor 110 includes outer regions 205 and a center region 207. In the center region 207, the ratio of Sn to Zn remains relatively unchanged over time and temperature. For example, the ratio of the Sn to Zn may be 91 parts Sn to 9 parts Zn by weight. In the outer regions 205, the ratio of Sn to Zn may increase. It can be shown that the melting point of the sensor 110 in the outer regions 205 is higher than the melting point in the center region 207 because of the increased concentration of Sn in the outer regions 205. This change in composition of the sensor 110 changes the overall characteristics of the sensor 110. If too much Zn is allowed to migrate out of the sensor 110, then the effective activation temperature or melting point of the sensor 110 may exceed the original activation temperature. For example, the activation temperature of the sensor 110 may initially be 199° C., but over time during operation in high temperature environments, the activation temperature of the sensor 110 may increase to a temperature in excess of 217° C., which is the temperature at which bonding pads in a field-effect-transistor FET may melt. If the activation temperature of the sensor 110 were to rise above the temperature at which bonding pads in the FET may melt, the thermal fuse may not be able to activate before damage to or detachment of the FET occurs.

To overcome the problems of the Zn migration, in some implementations, the overall thickness of the sensor 110 along the Y axis is increased so that the effective activation temperature of the sensor 110 remains essentially unchanged over the design life of the thermal fuse. For example, the design life of a thermal fuse operating in an automotive engine compartment environment may be about 10 years. The design life of the thermal fuse may be increased or decreased by changing the thickness of the sensor 110. For example, increasing the thickness may increase the design life and decreasing the thickness may decrease the design life. It can be shown that if the thickness T 215 from the top surface 110a and the bottom surface 110b of the sensor 110 to a center line 210 of the sensor 110 that extends along the X axis is about 0.10 mm (0.004 inch), giving a total thickness from the top surface 110a to the bottom surface 110b of about 0.20 mm (0.008 inch), the ratio of Sn to Zn in the center region 207 of the sensor 110 remains generally unchanged over temperature, humidity, and composition of the surfaces that contact the sensor 110. Therefore, the sensor 110 activation temperature will remain essentially unchanged over the design life when operated in a high temperature environment.

It may be shown that the Zn tends to migrate onto contact surfaces in contact with the sensor 110 until the contact surfaces become saturated with Zn. To maintain a given ratio over the design life of the thermal fuse, in some implementations excess Zn may be added to the sensor 110 to compensate for the Zn migration onto the contact surfaces.

In other implementations, Zn migration out of the sensor 110 may be minimized by making the surfaces that contact the sensor 110 from a material that includes Ni, gold (Au), aluminum (Al), palladium (Pd), and/or Zn, or other similar material. For example, referring to FIG. 1, the contact surface 109a of the first end 109 of the spring bar 105 and the substrate 115 may be made of a material that includes Ni, Au, Al, Pd, and/or Zn.

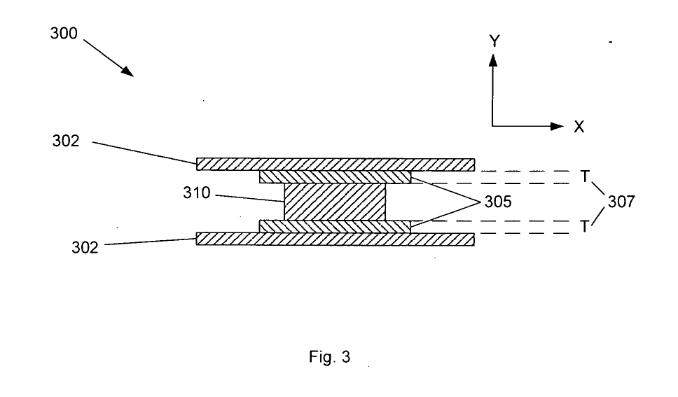

FIG. 3 illustrates another sensor configuration 300 for minimizing Zn migration from a sensor 310. Shown in the configuration 300 are a sensor 310, layers 305, which may be Ni, and contact surfaces 302. In some implementations, the sensor 310 may include an alloy comprising Sn and Zn as described above. The ratio of the Sn to Zn may be 91 parts Sn to 9 parts Zn by weight. Layers 305 may be referred to hereinafter as first layer and second layer.

The contact surfaces 302 may correspond to the contact surface 109a on the first end 109 of the spring bar 105, and also the substrate 115 shown in FIG. 1.

The layer 305 may be deposited or disposed between the contact surfaces 302 and the sensor 310. It can be shown that a sufficiently pore free and uniform layer of Ni deposited in between the contact surfaces 302 and the sensor 310 will minimize Zn migration from the sensor 310. In some implementations, a sufficiently pore free and uniform layer of Ni may be achieved when the thickness T 307 of the layer 305 is about 0.0023 mm (0.000090 inch) or greater.

To further enhance the characteristics of the sensor 310 the various embodiments described above may be combined. For example, the thickness from the top surface and bottom surface of the sensor 310 to a center line of the sensor 310 that extends along the X axis of the sensor may be configured to be about 0.10 mm (0.004 inch) or greater, i.e. giving a total thickness from the top surface to the bottom surface of the sensor of 0.20 mm (0.008 inch) or greater, as described above. In addition or alternatively, the layer 305 of the sensor 310 may be made from a material that includes Ni, Au, Al, Pd and/or Zn. For example, if Ni is used as layer 305 having a thickness T307 of about 0.0023 mm (0.000090 inch) in combination with a total sensor thickness of 0.20 mm, Zn migration out of the sensor 310 can be reduced so that the activation temperature of the sensor 310 remains generally unchanged over the design life of the thermal fuse when operated in a high temperature environment.

The implementations described above, therefore, overcome the problem of operating a thermal fuse in a high ambient temperature environment by providing a sensor 310 with an activation temperature that remains generally unchanged in high ambient temperature environments. This enables the manufacture of thermal fuses suitable for high temperature environments, such as an engine compartment of an automobile.

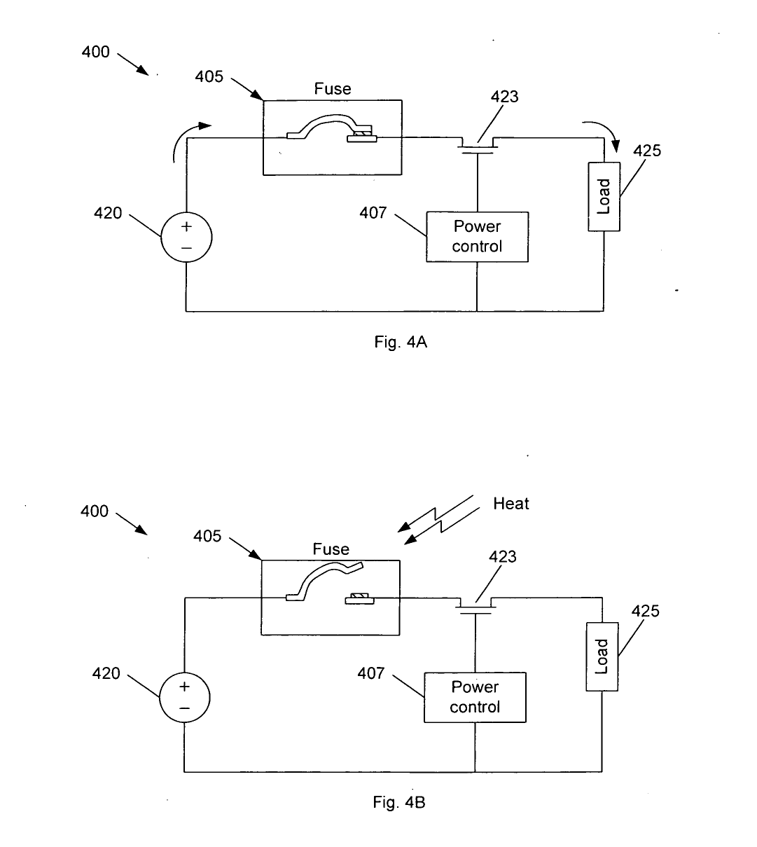

FIG. 4A is a schematic representation of a circuit 400 that includes a thermal fuse 405 with one or more of the properties described above. Shown are a thermal fuse 405, a power source 420, a switching device 423, a power control circuit 407, and a load 425. The thermal fuse 405 is connected in-between and in series with the power source 420 and a first terminal of the switching device 423. A second terminal of the switching device 423 may be driven by the power control circuit 407. A third terminal of the switching device 423 may be connected to the load 425.

The switching device 423 may correspond to a field-effect-transistor (FET) or other semiconductor switching device. For example, the first, second, and third terminals may correspond to the drain, gate, and source, respectively, of a FET. The power control circuit 407 may correspond to a circuit operable to regulate voltage and/or current delivered to the load 425. The power control circuit 407 may generate a pulse pattern or other signal that causes the switching device 443 to “open” and “close” and therefore output, via the third terminal, an average DC voltage. The load 425 may include one or more passive and/or active circuit components. For example, the load 425 may include resistors, capacitor, inductors, semiconductor circuits and transistors. The load 425 may include other devices.

The thermal fuse 405 may correspond to the thermal fuse 100 of FIG. 1. When the ambient temperature surrounding the thermal fuse 405 is below the activation temperature of the thermal fuse 405, the thermal fuse remains in a closed state and current flows from the power source 420, through the thermal fuse 405, and to the load 425. For example, in some implementations, when the ambient temperature is below about 199° C., the thermal fuse 405 remains in a closed state and current flows through the thermal fuse 405.

FIG. 4B, illustrates a thermal fuse in an environment where the ambient temperature of the circuit 400 exceeds the activation temperature of the thermal fuse 405. Under these conditions, the sensor in the thermal fuse 405 may begin to lose its resilience. For example, the sensor in the thermal fuse 405 may begin to change from a solid state to a liquid state. When this occurs, the sensor begins to lose its ability to adhere to the contact surfaces, such as the contact surface 109a (FIG. 1) of the second end 109 (FIG. 1) of the spring bar 105 (FIG. 1), and also the first substrate 115 (FIG. 1). In this state, elastic energy stored in the spring bar 105 causes the spring bar 105 to separate from the first substrate 115, which places the thermal fuse 405 in an open electrical state effectively disconnecting the load 425 from the power source 420. The thermal fuse is, therefore, capable of protecting circuits that operate in high temperature environments for extended periods of time such as in an engine compartment of an automobile.

While the thermal fuse and the method for using the thermal fuse have been described with reference to certain embodiments, it will be understood by those skilled in the art that various changes may be made and equivalents may be substituted without departing from the scope of the claims of the application. For example, one of ordinary skill will appreciate that the thickness of the sensor may be increased. Other contact surface materials that do not absorb Zn may be utilized. A material, other than Ni, that limits Zn migration may be deposited on the contact surfaces. Furthermore, the solutions described may be combined.

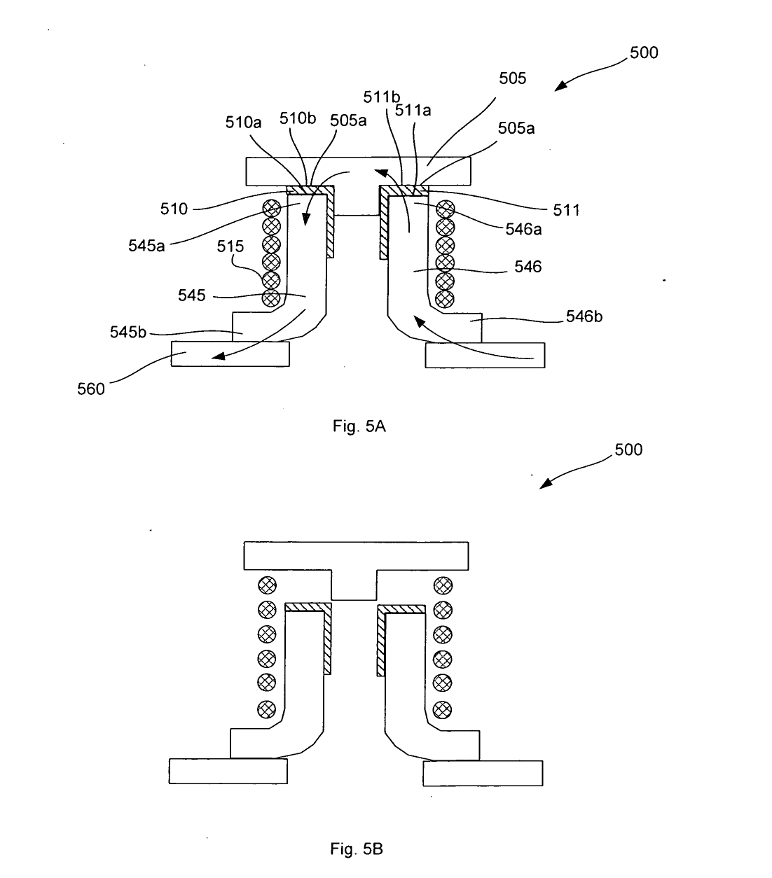

In addition to these modifications, many other modifications may be made to adapt a particular situation or material to the teachings without departing from the scope of the claims. For example, the sensor may be adapted to operate in the thermal fuse of FIG. 5A.

FIG. 5A illustrates a second exemplary thermal 500 fuse in a closed state. The thermal fuse 500 includes first and second end structures 545 and 546, a middle structure 505, first and second sensors 510 and 511, and a spring 515. The first end, middle, and second end structures (545, 505 and 546) may be made of any conductive material, such as copper, aluminum or other metal, or a conductive alloy. The first and second end structures 545 and 546 are separated from one another so that no current may flow directly between the first and second end structures 545 and 546. The first and second end structures 545 and 546 each include a first end 545a and 546a and a second end 545b and 546b. The first end 545a and 546a of each structure includes a contact surface configured to adhere to a bottom surface 510a and 511a of the first and second sensor 510 and 511, respectively.

The second end 545b and 546b of the first and second end structures 545 and 546, respectively, is configured to adhere to a substrate 560 or a printed circuit board pad.

The middle structure 505 is configured to bridge the first and second end structures 545 and 546 and includes a pair of contact surfaces 505a. Each contact surface 505a is configured to adhere to a top surface 510b and 511b of the first and second sensor 510 and 511, respectively.

The first and second sensors 510 and 511 may correspond to the sensor 110 described above. For example, the sensors 510 and 511 have a width across an X axis and a thickness along a Y axis. The sensors 510 and 511 may be made of an alloy that is in a solid state below a melting temperature of the alloy. The sensors 510 and 511 may melt or lose their resilience above the melting temperature. The melting temperature may correspond to the activation temperature of the thermal fuse 500.

The spring 515 may be generally cylindrically shaped and may include a spiral round elastic material such as metal, an alloy, plastic, or other elastic material. The spring 515 may be positioned over the first and second end structures 545 and 546 and below the middle structure 505.

In operation, the thermal fuse 500 may be connected in-between and in series with a power source and a load, such as the power source 420 and load 425 shown in FIG. 4A. When the ambient temperature surrounding the thermal fuse 500 is below the activation temperature of the thermal fuse, the thermal fuse remains in closed stated and current flows through the thermal fuse and into the circuit. For example, current may flow from the first end structure 545, through a first sensor 510, into the middle structure 505, through a second sensor 511, and into the second end structure 546. During this mode of operation, the spring 515 is held in a compressed state between the middle structure 505 and the first and second end structures 545 and 546.

When the ambient temperature around the thermal fuse 500 exceeds the activation temperature of the thermal fuse 500, the sensors 510 and 511 may begin to lose their resilience. Under these conditions, the sensors 510 and 511 may lose their ability to adhere to the contact surfaces on the first and second end structures 545 and 546 and the middle structure 505, respectively. After this occurs, energy stored in the spring 515 forces the middle structure 505 to separate from the first and second end structures 545 and 546, as shown in FIG. 5B. Current stops flowing through the thermal fuse 500 after the middle structure 505 separates from the first and second structures 545 and 546.

In addition to these modifications, yet other modifications may be made. For example, the thermal fuses described above may be configured to be placed on a circuit board or substrate via a reflow processes. For example, a retaining wire (not shown) may be configured to secure the thermal fuse to prevent premature activation during the reflow process, as described in U.S. patent application Ser. No. 12/383,560 (Matthiesen et al.), filed Mar. 24, 2009, and U.S. patent application Ser. No. 12/383,595 (Galla et al.), filed Mar. 24, 2009, which are hereby incorporated by reference in their entirety. Therefore, it is intended that thermal fuse and method for using the thermal fuse are not to be limited to the particular embodiments disclosed, but to any embodiments that fall within the scope of the claims.

What is claimed is:

1. A thermal fuse comprising:
a first contact surface;
a sensor comprising a mixture of tin (Sn) and zinc (Zn) having a ratio and a melting temperature, the sensor defining a top surface, a center region, and a bottom surface, wherein the top surface is connected to the first contact surface and wherein a distance between the top surface and the bottom surface of the sensor is sized to substantially maintain the ratio of Sn to Zn in the center region of the sensor when a temperature of the sensor is below the melting temperature; and
a second contact surface connected to the bottom surface of the sensor;
wherein when the temperature of the sensor is below the melting temperature the center region of the sensor prevents the first contact surface and the second contact surface from separating, and when the center region of the sensor is above the melting temperature, the sensor loses resilience,
the first contact surface and the second contact surface being configured to separate when the sensor loses resilience.

2. The thermal fuse according to claim 1, wherein a distance from the top surface of the sensor to a centerline of the sensor is at least 0.0625 mm (0.0025 inch).

3. The thermal fuse according to claim 1, wherein the sensor includes a mixture of 91 parts Sn to 9 parts Zn by weight.

4. The thermal fuse according to claim 1, wherein the first contact surface and the second contact surface comprise an element selected from the group consisting of Ni, Au, Al, Pd, and Zn.

5. The thermal fuse according to claim 1, further comprising a first layer over the first contact surface and a second layer over the second contact surface configured to substantially prevent Zn migration onto the first contact surface and the second contact surface, respectively.

6. The thermal fuse according to claim 5, wherein the first layer and the second layer comprise nickel (Ni) with a thickness of at least 0.0023 mm (0.000090 inch).

7. The thermal fuse according to claim 1, further comprising a spring bar, wherein the first contact surface is positioned at an end of the spring bar and the second contact surface is fixed to a substrate.

8. The thermal fuse according to claim 1, wherein the thermal fuse is configured to be installed via a reflow process.

9. A thermal fuse comprising:
a first contact surface;
a sensor comprising a mixture of tin (Sn) and zinc (Zn) having a melting temperature, the sensor defining a top surface and a bottom surface, the top surface of the sensor connected to the first contact surface; and
a second contact surface connected to the bottom surface of the sensor;
wherein the first and second contact surfaces are made of an element that substantially limits Zn migration out of the sensor and onto either the first or second contact surface when a temperature of the sensor is below the melting temperature, and when the sensor is above the melting temperature, the sensor loses resilience,
wherein the first contact surface and the second contact surface are configured to separate when the sensor loses resilience

10. The thermal fuse according to claim 9, wherein the first and second contact surfaces include an element selected from the group consisting of: Ni, Au, Al, Pd, and Zn.

11. The thermal fuse according to claim 9, wherein the sensor includes a mixture of 91 parts Sn to 9 parts Zn by weight.

12. The thermal fuse according to claim 9, further comprising a spring bar, wherein one of the first contact surface and the second contact surface is positioned at an end of the spring bar and the other contact surface of the first contact surface and the second contact surface is fixed to a substrate.

13. The thermal fuse according to claim 9, further comprising a coil spring configured to move the first and second contact surfaces away from one another.

14. The thermal fuse according to claim 9, further comprising a retaining wire configured to prevent the first and second contact surfaces from moving apart.

15. A thermal fuse comprising:
a first contact surface;
a first layer disposed on the first contact surface;
a second contact surface;
a second layer disposed on the second contact surface; and
a sensor disposed between the first layer of the first contact surface and the second layer of the second contact surface;
wherein the first layer and the second layer are configured to substantially prevent Zn migration onto the first and second contact surfaces,
wherein the sensor loses resilience when the temperature of the sensor is above a melting temperature of the sensor, and
wherein the first contact surface and the second contact surface are configured to separate when the sensor loses resilience.

16. The thermal fuse according to claim 5, wherein the first layer and second layer comprise nickel (Ni) with a thickness of at least 0.0023 mm (0.000090 inch).

17. The thermal fuse according to claim 15, wherein the sensor includes a mixture of 91 parts Sn to 9 parts Zn by weight.

18. The thermal fuse according to claim 15, further comprising a spring bar, wherein the first contact surface is positioned at an end of the spring bar and the second contact surface is fixed to a substrate.

19. The thermal fuse according to claim 15, further comprising a coil spring configured to move the first and second contacts away from one another.

20. The thermal fuse according to claim 15, further comprising a retaining wire configured to prevent the first and second contacts from moving apart.
